(19) United States
(12) Patent Application Publication
(10) Pub. No.: US 2008/0155339 A1
(43) Pub. Date: Jun. 26, 2008

(54) AUTOMATED TRACING

(76) Inventors: Gary S Lowe, Cedar Park, TX (US); Jayashkumar M. Patel, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/552,701

(22) Filed: Oct. 25, 2006

(51) Int. Cl. G06F 11/00

(52) U.S. Cl. 714/38

(57) ABSTRACT

A method, system and computer-readable medium for dynamically and automatically adjusting trace points in software code are presented. In one embodiment, the method includes, but is not limited to, the steps of: embedding, into a software thread, code that causes an adjustment of tracing parameters in response to a pre-defined condition; and in response to determining that the pre-defined condition has been met, adjusting the tracing parameters. The method may further include the step of adjusting a buffer size according to the adjusting of the tracing parameters. The pre-defined condition may be a jump from a first software thread to a second software thread, wherein the second software thread has a history of causing an execution warning. Alternatively, the pre-defined condition may be a particular hard or soft architected state of a processor that is currently executing software that is being traced.

### BACKGROUND OF THE INVENTION

1. Technical Field

The present invention relates in general to the field of data processing, and, in particular, to an improved method for tracing software code.

2. Description of the Related Art

When looking for problems with software code that is executing, a software developer relies heavily on trace records that are generated by fixed trace points embedded in the software code. By using an Application Program Interface (API) such as IBM's Performance Explorer (PEX), or through the use of some similar feature found in an Integrated Development Environment (IDE), executing software generates a trace record of event types and event subtypes that are described and tracked by the fixed trace points. This trace record includes data captured from hardware performance counters that are associated with a currently executing software thread. These hardware performance counters measure parameters such as Central Processing Unit (CPU) usage time, Input/Output (I/O) activity, timing signals, memory usage, etc. Thus, through the use of trace points, the software developer is able to determine likely causes of an error produced during the execution of the software code.

In the prior art, if a fixed trace point does not provide the software developer with enough information to debug the executing software code, then the software code is re-written with a new trace statement, the code is re-compiled to produce a new fixed trace command, and the compiled code is executed using the new fixed trace command. This process must be reiterated until adequate runtime information is generated to identify the source of the problem in the code. Such reiterations of recoding, recompiling, and re-executing are slow, tedious, and error-prone.

### SUMMARY OF THE INVENTION

To address the problem described above, the present invention presents a method, system and computer-readable medium for dynamically and automatically adjusting trace points in software code. In one embodiment, the method includes, but is not limited to, the steps of: embedding, into a software thread, code that causes an adjustment of tracing parameters in response to a pre-defined condition; and in response to determining that the pre-defined condition has been met, adjusting the tracing parameters. The method may further include the step of adjusting a buffer size according to the adjusting of the tracing parameters, wherein a buffer is optimally sized to store data from adjusted tracing parameters.

The pre-defined condition, which causes the tracing parameters to be adjusted, may be a jump from a first software thread to a second software thread, wherein the second software thread has a history of causing an execution warning. Alternatively, the pre-defined condition may be a particular hard or soft architected state of a processor that is currently executing software that is being traced.

The above, as well as additional, purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIGS. 1A-C depict a high-level overview of the dynamic tracing aspects found in the present invention;

FIG. 2 illustrates an exemplary computer system in which the present invention may be implemented;

FIGS. 3A-C depict additional detail of hardware architecture found in a processor unit shown in FIG. 2;

FIG. 4 is a flow-chart of exemplary steps taken by the present invention to dynamically adjust tracing parameters during debugging operations;

FIGS. 5A-B show a flow-chart of steps taken to deploy software capable of executing the steps shown and described in FIGS. 1A-C and FIG. 4; and

FIGS. 6A-B show a flow-chart showing steps taken to execute the steps shown and described in FIGS. 1A-C and FIG. 4 using an on-demand service provider.

### DETAILED DESCRIPTION OF THE PREFERRED EMBODIMENT

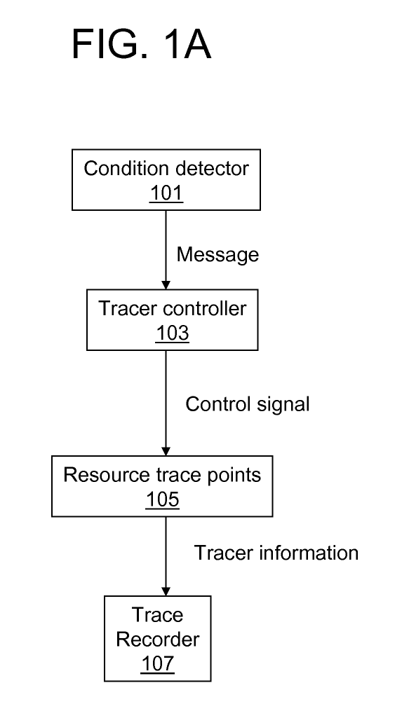

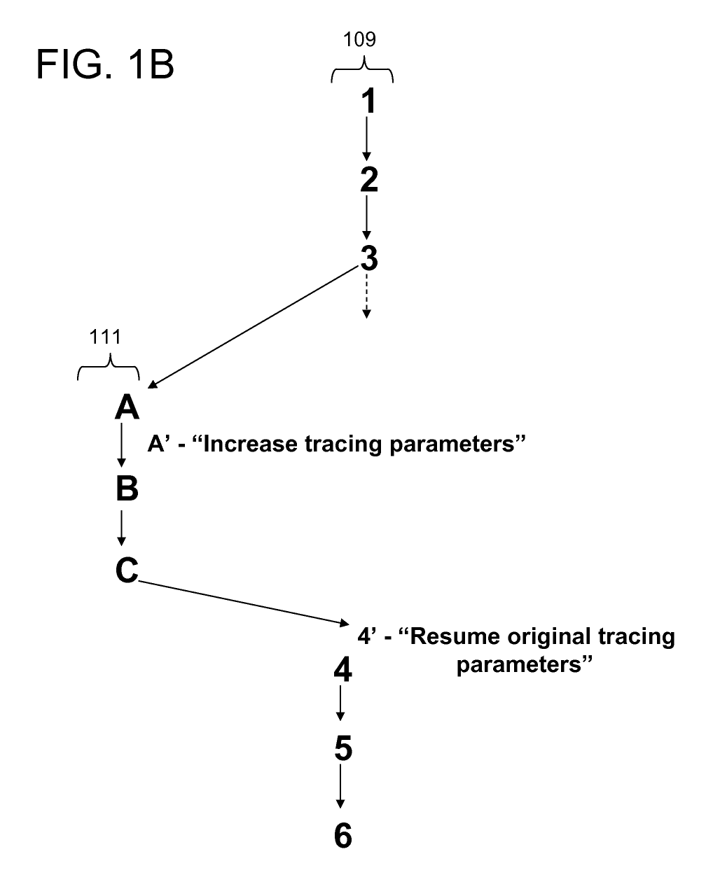

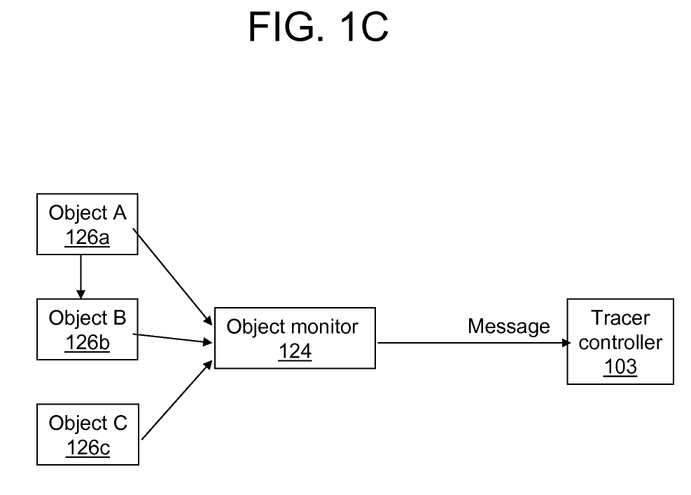

With reference now to the figures, and in particular to FIG. 1A, a high-level overview of a preferred embodiment of the present invention is presented. First, a condition detector 101 detects a hardware problem (e.g., an overheating CPU) or software issue (e.g., a jump to software that historically has suggested some type of hardware or software problem). The condition detector 101 then sends a message to a tracer controller 103. This message instructs the tracer controller 103 to adjust the number tracing parameters that are monitored. The tracer controller 103 then sends a control signal, to various trace points 105 in a resource (hardware or software), instructing more trace points 105 to begin collecting trace point information (data). These trace points 105 may be hardware monitors or software monitors. The trace points 105 then send their respectively collected trace point information to a trace recorder 107, which stores the trace point information for further and future analysis. Details of this process are now presented.

Referring now to FIG. 1B, an example of what condition detector 101 may detect, thus resulting in a message being sent to the tracer controller 103, is presented. Assume that a first thread 109 of software, having code lines 1-6, is being executed. However, when the instruction pointer gets to line 3, a jump (or branch) instruction is issued, causing a jump to line A of a second thread 111 of software. As contemplated by the present invention, second thread 111 includes a new piece of code labeled A′, which has been inserted into second thread 111 in accordance with the present invention. A′ causes tracer controller 103 to issue a control signal that causes additional trace points 105 to come on line. These additional trace points 105 send trace information to the trace recorder 107 until execution returns to first thread 109, at which point an instruction 4′ (which has been inserted into first thread 109 in accordance with the present invention) sends a new message to tracer controller 103 to reduce the number of trace points 105 back down to the original number used before instruction A′.

Note that the instruction A′ had been previously encoded within second thread 111 by the software developer. The software developer's reasons for including instruction A′ vary. For example, second thread 111 may have a history of frequently causing an error when executed. Alternatively, every time second thread 111 has been called in the past, a warning message may show up for first thread 109 (or any other thread) during execution. Thus, pseudocode for A′ may be:
If first thread 109 called second thread 111
   Then increase tracing parameters

The example for A′ is for illustrative purposes only, and should not be construed as limiting the scope of the present invention. For example, consider now FIG. 1C. An object monitor 124 monitors how often one or more objects 126a-c are called. Assume that Object A (126a) is run with unusual frequency (e.g., thirty times during one minute of execution time on a particular machine), or that a warning occurs whenever Object B (126b) is called by Object A. Object monitor 124 determines the significance of such events, and sends an instruction to tracer controller 103 to adjust tracing parameters in a manner described above. In such a situation, pseudocode may read:
If Object A is called more than 30 times within one minute or
If Object A calls Object B and an execution warning subsequently occurs
   Then increase tracing parameters

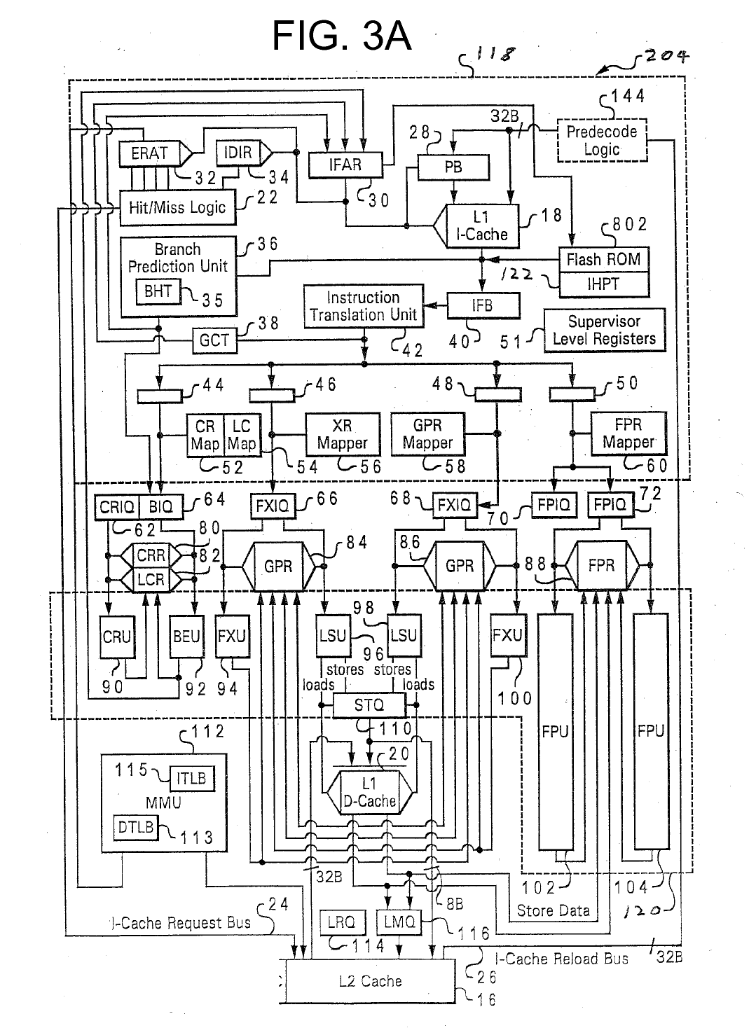

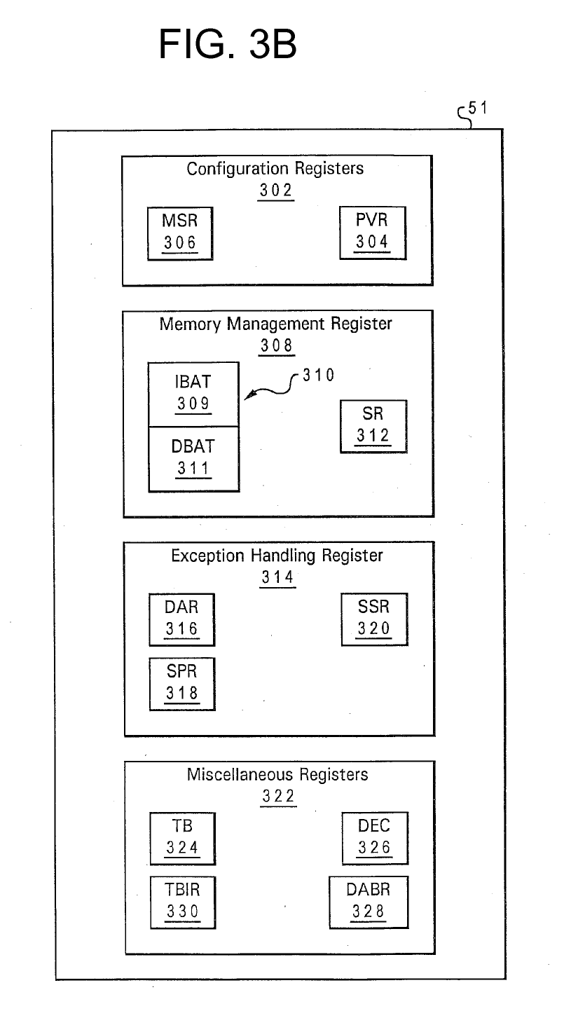

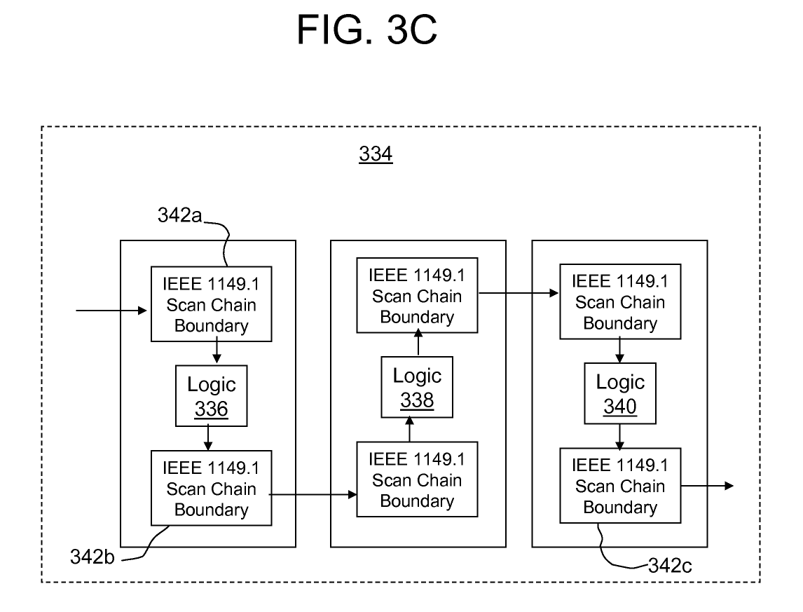

Furthermore, A′ may increase tracing parameters because of a system state (discussed in further detail below in FIGS. 3A-B), a scan chain signal (discussed in FIG. 3C), or any other criteria established by the software developer.

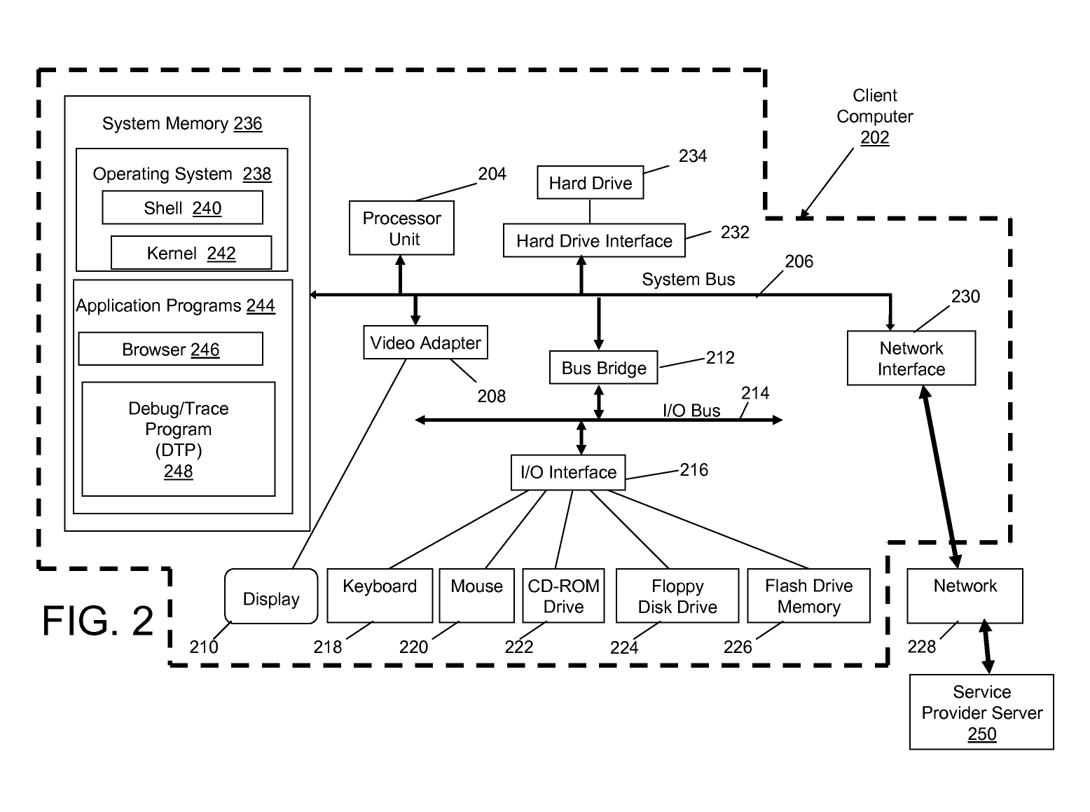

Before discussing detailed steps taken by the present invention for dynamically adjusting trace points, a review of various parameters that may be used in such adjustment, along with their technological context, is now presented. Thus, with reference to FIG. 2, there is depicted a block diagram of an exemplary client computer 202, in which the present invention may be utilized. Client computer 202 may be used during debugging operations of a hardware-independent piece of software code.

Alternatively, client computer 202 may be a first client computer that is used to monitor debugging operations in a second client computer that has a similar architecture as client computer 202. Under this scenario, software errors may be related to hardware states in the second client computer. Thus, the first client computer monitors software conditions, hardware conditions, and architected states, as will be described in further detail below.

Client computer 202 includes a processor unit 204 that is coupled to a system bus 206. A video adapter 208, which drives/supports a display 210, is also coupled to system bus 206. System bus 206 is coupled via a bus bridge 212 to an Input/Output (I/O) bus 214. An I/O interface 216 is coupled to I/O bus 214. I/O interface 216 affords communication with various I/O devices, including a keyboard 218, a mouse 220, a Compact Disk-Read Only Memory (CD-ROM) drive 222, a floppy disk drive 224, and a flash drive memory 226. The format of the ports connected to I/O interface 216 may be any known to those skilled in the art of computer architecture, including but not limited to Universal Serial Bus (USB) ports.

Client computer 202 is able to communicate with a service provider server 250 via a network 228 using a network interface 230, which is coupled to system bus 206. Network 228 may be an external network such as the Internet, or an internal network such as an Ethernet or a Virtual Private Network (VPN).

A hard drive interface 232 is also coupled to system bus 206. Hard drive interface 232 interfaces with a hard drive 234. In a preferred embodiment, hard drive 234 populates a system memory 236, which is also coupled to system bus 206. System memory is defined as a lowest level of volatile memory in client computer 202. This volatile memory includes additional higher levels of volatile memory (not shown), including, but not limited to, cache memory, registers and buffers. Data that populates system memory 236 includes client computer 202's operating system (OS) 238 and application programs 244.

OS 238 includes a shell 240, for providing transparent user access to resources such as application programs 244. Generally, shell 240 is a program that provides an interpreter and an interface between the user and the operating system. More specifically, shell 240 executes commands that are entered into a command line user interface or from a file. Thus, shell 240 (as it is called in UNIX®, also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 242) for processing. Note that while shell 240 is a text-based, line-oriented user interface, the present invention will equally well support other user interface modes, such as graphical, voice, gestural, etc.

As depicted, OS 238 also includes kernel 242, which includes lower levels of functionality for OS 238, including the provision of essential services required by other parts of OS 238 and application programs 244, including memory management, process and task management, disk management, and mouse and keyboard management.

Application programs 244 include a browser 246. Browser 246 includes program modules and instructions enabling a World Wide Web (WWW) client (i.e., client computer 202) to send and receive network messages to the Internet using HyperText Transfer Protocol (HTTP) messaging, thus enabling communication with service provider server 250. In one embodiment of the present invention, service provider server 250 may utilize a same or substantially similar architecture as shown and described for client computer 202.

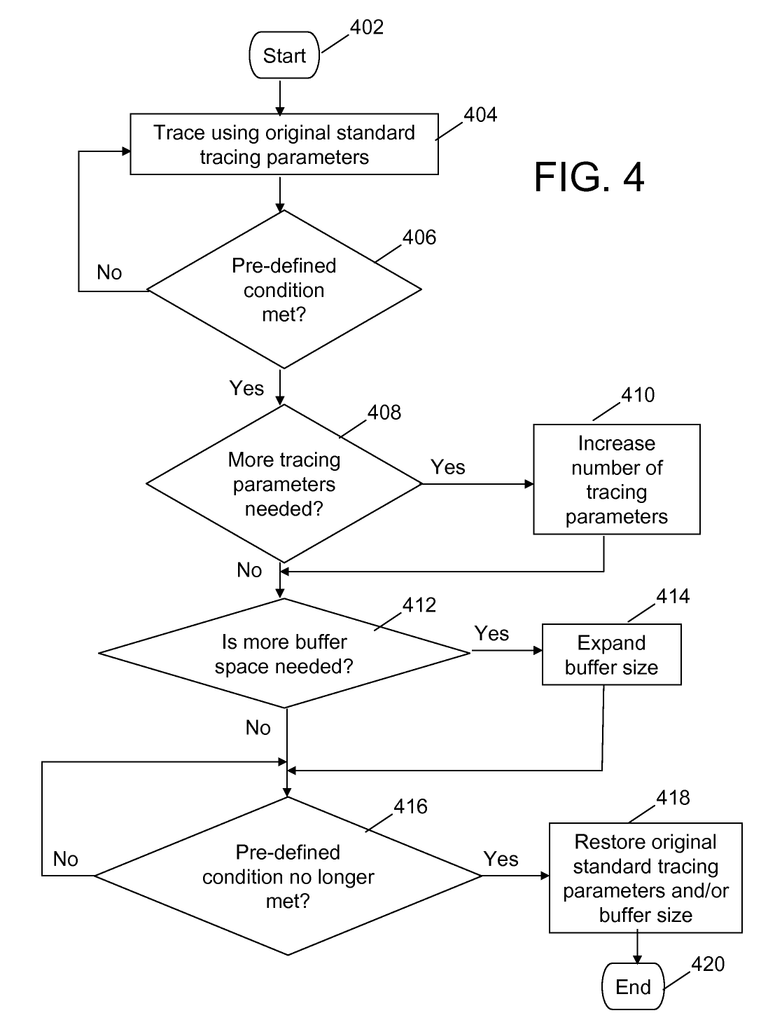

In the scenario described above in which a first client computer 202 monitors the tracing and debugging of software in a second client computer 202, application programs 244 in the second client computer 202's system memory also include a Debug/Trace Program (DTP) 248. DTP 248 includes code for implementing the processes described in FIGS. 1A-C and FIG. 4. In one embodiment, client computer 202 is able to download DTP 248 from service provider server 250.

The hardware elements depicted in client computer 202 are not intended to be exhaustive, but rather are representative to highlight essential components required by the present invention. For instance, client computer 202 may include alternate memory storage devices such as magnetic cassettes, Digital Versatile Disks (DVDs), Bernoulli cartridges, and the like. These and other variations are intended to be within the spirit and scope of the present invention.

Note further that, in a preferred embodiment of the present invention, service provider server 250 performs all of the functions associated with the present invention (including execution of DTP 248), thus freeing client computer 202 from having to use its own internal computing resources to execute DTP 248.

Reference is now made to FIG. 3A, which shows additional detail for processing unit 204. Such detail is particularly relevant in the scenario described above, in which a first client computer 202 monitors and debugs software being executed in a second client computer 202. Thus, the detail shown for processing unit 204 is particularly relevant for the second client computer 202 that is running software that is being traced/debugged. More specifically, a resource trace point 105 (shown in FIG. 1A) can be placed on any component described below in processing unit 204, including storage units that contain soft and hard architected states for processing unit 204.

Processing unit 204 includes an on-chip multi-level cache hierarchy including a unified level two (L2) cache 16 and bifurcated level one (L1) instruction (I) and data (D) caches 18 and 20, respectively. As is well-known to those skilled in the art, caches 16, 18 and 20 provide low latency access to cache lines corresponding to memory locations in system memories 236 (shown in FIG. 2).

Instructions are fetched for processing from L1 I-cache 18 in response to the effective address (EA) residing in instruction fetch address register (IFAR) 30. During each cycle, a new instruction fetch address may be loaded into IFAR 30 from one of three sources: branch prediction unit (BPU) 36, which provides speculative target path and sequential addresses resulting from the prediction of conditional branch instructions, global completion table (GCT) 38, which provides flush and interrupt addresses, and branch execution unit (BEU) 92, which provides non-speculative addresses resulting from the resolution of predicted conditional branch instructions. Associated with BPU 36 is a branch history table (BHT) 35, in which are recorded the resolutions of conditional branch instructions to aid in the prediction of future branch instructions.

An effective address (EA), such as the instruction fetch address within IFAR 30, is the address of data or an instruction generated by a processor. The EA specifies a segment register and offset information within the segment. To access data (including instructions) in memory, the EA is converted to a real address (RA), through one or more levels of translation, associated with the physical location where the data or instructions are stored.

Within processing unit 204, effective-to-real address translation is performed by memory management units (MMUs) and associated address translation facilities. Preferably, a separate MMU is provided for instruction accesses and data accesses. In FIG. 3A, a single MMU 112 is illustrated, for purposes of clarity, showing connections only to instruction sequencing unit (ISU) 118. However, it is understood by those skilled in the art that MMU 112 also preferably includes connections (not shown) to load/store units (LSUs) 96 and 98 and other components necessary for managing memory accesses. MMU 112 includes data translation lookaside buffer (DTLB) 113 and instruction translation lookaside buffer (ITLB) 115. Each TLB contains recently referenced page table entries, which are accessed to translate EAs to RAs for data (DTLB 113) or instructions (ITLB 115). Recently referenced EA-to-RA translations from ITLB 115 are cached in EOP effective-to-real address table (ERAT) 32.

If hit/miss logic 22 determines, after translation of the EA contained in IFAR 30 by ERAT 32 and lookup of the real address (RA) in I-cache directory 34, that the cache line of instructions corresponding to the EA in IFAR 30 does not reside in L1 I-cache 18, then hit/miss logic 22 provides the RA to L2 cache 16 as a request address via I-cache request bus 24. Such request addresses may also be generated by prefetch logic within L2 cache 16 based upon recent access patterns. In response to a request address, L2 cache 16 outputs a cache line of instructions, which are loaded into prefetch buffer (PB) 28 and L1 I-cache 18 via I-cache reload bus 26, possibly after passing through optional predecode logic 144.

Once the cache line specified by the EA in IFAR 30 resides in L1 cache 18, L1 I-cache 18 outputs the cache line to both branch prediction unit (BPU) 36 and to instruction fetch buffer (IFB) 40. BPU 36 scans the cache line of instructions for branch instructions and predicts the outcome of conditional branch instructions, if any. Following a branch prediction, BPU 36 furnishes a speculative instruction fetch address to IFAR 30, as discussed above, and passes the prediction to branch instruction queue 64 so that the accuracy of the prediction can be determined when the conditional branch instruction is subsequently resolved by branch execution unit 92.

IFB 40 temporarily buffers the cache line of instructions received from L1 I-cache 18 until the cache line of instructions can be translated by instruction translation unit (ITU) 42. In the illustrated embodiment of processing unit 304, ITU 42 translates instructions from user instruction set architecture (UISA) instructions into a possibly different number of internal ISA (IISA) instructions that are directly executable by the execution units of processing unit 304. Such translation may be performed, for example, by reference to microcode stored in a read-only memory (ROM) template. In at least some embodiments, the UISA-to-IISA translation results in a different number of IISA instructions than UISA instructions and/or IISA instructions of different lengths than corresponding UISA instructions. The resultant IISA instructions are then assigned by global completion table 38 to an instruction group, the members of which are permitted to be dispatched and executed out-of-order with respect to one another. Global completion table 38 tracks each instruction group for which execution has yet to be completed by at least one associated EA, which is preferably the EA of the oldest instruction in the instruction group.

Following UISA-to-IISA instruction translation, instructions are dispatched to one of latches 44, 46, 48 and 50, possibly out-of-order, based upon instruction type. That is, branch instructions and other condition register (CR) modifying instructions are dispatched to latch 44, fixed-point and load-store instructions are dispatched to either of latches 46 and 48, and floating-point instructions are dispatched to latch 50. Each instruction requiring a rename register for temporarily storing execution results is then assigned one or more rename registers by the appropriate one of CR mapper 52, link and count (LC) register mapper 54, exception register (XER) mapper 56, general-purpose register (GPR) mapper 58, and floating-point register (FPR) mapper 60.

The dispatched instructions are then temporarily placed in an appropriate one of CR issue queue (CRIQ) 62, branch issue queue (BIQ) 64, fixed-point issue queues (FXIQs) 66 and 68, and floating-point issue queues (FPIQs) 70 and 72. From issue queues 62, 64, 66, 68, 70 and 72, instructions can be issued opportunistically to the execution units of processing unit 10 for execution as long as data dependencies and antidependencies are observed. The instructions, however, are maintained in issue queues 62-72 until execution of the instructions is complete and the result data, if any, are written back, in case any of the instructions needs to be reissued.

As illustrated, the execution units of processing unit 204 include a CR unit (CRU) 90 for executing CR-modifying instructions, a branch execution unit (BEU) 92 for executing branch instructions, two fixed-point units (FXUs) 94 and 100 for executing fixed-point instructions, two load-store units (LSUs) 96 and 98 for executing load and store instructions, and two floating-point units (FPUs) 102 and 104 for executing floating-point instructions. Each of execution units 90-104 is preferably implemented as an execution pipeline having a number of pipeline stages.

During execution within one of execution units 90-104, an instruction receives operands, if any, from one or more architected and/or rename registers within a register file coupled to the execution unit. When executing CR-modifying or CR-dependent instructions, CRU 90 and BEU 92 access the CR register file 80, which in a preferred embodiment contains a CR and a number of CR rename registers that each comprise a number of distinct fields formed of one or more bits. Among these fields are LT, GT, and EQ fields that respectively indicate if a value (typically the result or operand of an instruction) is less than zero, greater than zero, or equal to zero. Link and count register (LCR) register file 82 contains a count register (CTR), a link register (LR) and rename registers of each, by which BEU 92 may also resolve conditional branches to obtain a path address. General-purpose register files (GPRs) 84 and 86, which are synchronized, duplicate register files, store fixed-point and integer values accessed and produced by FXUs 94 and 100 and LSUs 96 and 98. Floating-point register file (FPR) 88, which like GPRs 84 and 86 may also be implemented as duplicate sets of synchronized registers, contains floating-point values that result from the execution of floating-point instructions by FPUs 102 and 104 and floating-point load instructions by LSUs 96 and 98.

After an execution unit finishes execution of an instruction, the execution notifies GCT 38, which schedules completion of instructions in program order. To complete an instruction executed by one of CRU 90, FXUs 94 and 100 or FPUs 102 and 104, GCT 38 signals the execution unit, which writes back the result data, if any, from the assigned rename register(s) to one or more architected registers within the appropriate register file. The instruction is then removed from the issue queue, and once all instructions within its instruction group have completed, is removed from GCT 38. Other types of instructions, however, are completed differently.

When BEU 92 resolves a conditional branch instruction and determines the path address of the execution path that should be taken, the path address is compared against the speculative path address predicted by BPU 36. If the path addresses match, no further processing is required. If, however, the calculated path address does not match the predicted path address, BEU 92 supplies the correct path address to IFAR 30. In either event, the branch instruction can then be removed from BIQ 64, and when all other instructions within the same instruction group have completed, from GCT 38.

Following execution of a load instruction, the effective address computed by executing the load instruction is translated to a real address by a data ERAT (not illustrated) and then provided to L1 D-cache 20 as a request address. At this point, the load instruction is removed from FXIQ 66 or 68 and placed in load reorder queue (LRQ) 114 until the indicated load is performed. If the request address misses in L1 D-cache 20, the request address is placed in load miss queue (LMQ) 116, from which the requested data is retrieved from L2 cache 16, and failing that, from another processing unit 202 or from system memory 236 (shown in FIG. 2). LRQ 114 snoops exclusive access requests (e.g., read-with-intent-to-modify), flushes or kills on an interconnect fabric against loads in flight, and if a hit occurs, cancels and reissues the load instruction. Store instructions are similarly completed utilizing a store queue (STQ) 110 into which effective addresses for stores are loaded following execution of the store instructions. From STQ 110, data can be stored into either or both of L1 D-cache 20 and L2 cache 16.

### Processor States

The state of a processor includes stored data, instructions and hardware states at a particular time, and are herein defined as either being “hard” or “soft.” The “hard” state is defined as the information within a processor that is architecturally required for a processor to execute a process from its present point in the process. The “soft” state, by contrast, is defined as information within a processor that would improve efficiency of execution of a process, but is not required to achieve an architecturally correct result. In processing unit 204 of FIG. 3A, the hard state includes the contents of user-level registers, such as CRR 80, LCR 82, GPRs 84 and 86, FPR 88, as well as supervisor level registers 51. The soft state of processing unit 204 includes both “performance-critical” information, such as the contents of L-1 I-cache 18, L-1 D-cache 20, address translation information such as DTLB 113 and ITLB 115, and less critical information, such as BHT 35 and all or part of the content of L2 cache 16.

The hard architected state is stored to system memory through the load/store unit of the processor core, which blocks execution of the interrupt handler or another process for a number of processor clock cycles. Alternatively, upon receipt of an interrupt, processing unit 204 suspends execution of a currently executing process, such that the hard architected state stored in hard state registers is then copied directly to shadow register. The shadow copy of the hard architected state, which is preferably non-executable when viewed by the processing unit 204, is then stored to system memory 236. The shadow copy of the hard architected state is preferably stored in a special memory area within system memory 236 that is reserved for hard architected states.

Saving soft states differs from saving hard states. When an interrupt handler is executed by a conventional processor, the soft state of the interrupted process is typically polluted. That is, execution of the interrupt handler software populates the processor's caches, address translation facilities, and history tables with data (including instructions) that are used by the interrupt handler. Thus, when the interrupted process resumes after the interrupt is handled, the process will experience increased instruction and data cache misses, increased translation misses, and increased branch mispredictions. Such misses and mispredictions severely degrade process performance until the information related to interrupt handling is purged from the processor and the caches and other components storing the process' soft state are repopulated with information relating to the process. Therefore, at least a portion of a process' soft state is saved and restored in order to reduce the performance penalty associated with interrupt handling. For example, the entire contents of L1 I-cache 18 and L1 D-cache 20 may be saved to a dedicated region of system memory 236. Likewise, contents of BHT 35, ITLB 115 and DTLB 113, ERAT 32, and L2 cache 16 may be saved to system memory 236.

Because L2 cache 16 may be quite large (e.g., several megabytes in size), storing all of L2 cache 16 may be prohibitive in terms of both its footprint in system memory and the time/bandwidth required to transfer the data. Therefore, in a preferred embodiment, only a subset (e.g., two) of the most recently used (MRU) sets are saved within each congruence class.

Thus, soft states may be streamed out while the interrupt handler routines (or next process) are being executed. This asynchronous operation (independent of execution of the interrupt handlers) may result in an intermingling of soft states (those of the interrupted process and those of the interrupt handler). Nonetheless, such intermingling of data is acceptable because precise preservation of the soft state is not required for architected correctness and because improved performance is achieved due to the shorter delay in executing the interrupt handler.

Management of both soft and hard architected states may be managed by a hypervisor, which is accessible by multiple processors within any partition. That is, Processor A and Processor B may initially be configured by the hypervisor to function as an SMP within Partition X, while Processor C and Processor D are configured as an SMP within Partition Y. While executing, processors A-D may be interrupted, causing each of processors A-D to store a respective one of hard states A-D and soft states A-D to memory in the manner discussed above. Any processor can access any of hard or soft states A-D to resume the associated interrupted process. For example, in addition to hard and soft states C and D, which were created within its partition, Processor D can also access hard and soft states A and B. Thus, any process state can be accessed by any partition or processor(s). Consequently, the hypervisor has great freedom and flexibility in load balancing between partitions.

### Registers

In the description above, register files of processing unit 204 such as GPR 86, FPR 88, CRR 80 and LCR 82 are generally defined as “user-level registers,” in that these registers can be accessed by all software with either user or supervisor privileges. Supervisor level registers 51 include those registers that are used typically by an operating system, typically in the operating system kernel, for such operations as memory management, configuration and exception handling. As such, access to supervisor level registers 51 is generally restricted to only a few processes with sufficient access permission (i.e., supervisor level processes).

As depicted in FIG. 3B, supervisor level registers 51 generally include configuration registers 302, memory management registers 308, exception handling registers 314, and miscellaneous registers 322, which are described in more detail below.

Configuration registers 302 include a machine state register (MSR) 306 and a processor version register (PVR) 304. MSR 306 defines the state of the processor. That is, MSR 306 identifies where instruction execution should resume after an instruction interrupt (exception) is handled. PVR 304 identifies the specific type (version) of processing unit 200.

Memory management registers 308 include block-address translation (BAT) registers 310. BAT registers 310 are software-controlled arrays that store available block-address translations on-chip. Preferably, there are separate instruction and data BAT registers, shown as IBAT 309 and DBAT 311. Memory management registers also include segment registers (SR) 312, which are used to translate EAs to virtual addresses (VAs) when BAT translation fails.

Exception handling registers 314 include a data address register (DAR) 316, special purpose registers (SPRs) 318, and machine status save/restore (SSR) registers 320. The DAR 316 contains the effective address generated by a memory access instruction if the access causes an exception, such as an alignment exception. SPRs are used for special purposes defined by the operating system, for example, to identify an area of memory reserved for use by a first-level exception handler (FLIH). This memory area is preferably unique for each processor in the system. An SPR 318 may be used as a scratch register by the FLIH to save the content of a general purpose register (GPR), which can be loaded from SPR 318 and used as a base register to save other GPRs to memory. SSR registers 320 save machine status on exceptions (interrupts) and restore machine status when a return from interrupt instruction is executed.

Miscellaneous registers 322 include a time base (TB) register 324 for maintaining the time of day, a decrementer register (DEC) 326 for decrementing counting, and a data address breakpoint register (DABR) 328 to cause a breakpoint to occur if a specified data address is encountered. Further, miscellaneous registers 322 include a time based interrupt register (TBIR) 330 to initiate an interrupt after a pre-determined period of time. Such time based interrupts may be used with periodic maintenance routines to be run on processing unit 200.

### Trace Points in a Scan Chain Pathway

Because of their complexity, processors and other ICs typically include circuitry that facilitates testing of the IC. The test circuitry includes a boundary scan chain as described in the Institute of Electrical and Electronic Engineers (IEEE) Standard 1149.1-1990, “Standard Test Access Port and Boundary Scan Architecture,” which is herein incorporated by reference in its entirety. The boundary scan chain which is typically accessed through dedicated pins on a packaged integrated circuit, provides a pathway for test data between components of an integrated circuit.

With reference now to FIG. 3C, there is depicted a block in accordance with the diagram of an integrated circuit 334 in accordance with the present invention. Integrated circuit 334 is preferably a processor, such as processing unit of 204 of FIG. 2. Integrated circuit 334 contains three logical components (logic) 336, 338 and 340, which, for purposes of explaining the present invention, comprise three of the memory elements that store the soft state of the process. For example, logic 336 may be L1 D-cache 20 shown in FIG. 3A, logic 338 may be ERAT 32, and logic 340 may be a portion of L2 cache 16 as described above. During manufacturer testing of integrated circuit 334, a signal is sent through the scan chains boundary cells 342, which are preferably clock controlled latches. A signal output by scan chain boundary cell 342a provides a test input to logic 336, which then outputs a signal to scan chain boundary cells 342b, which in turn sends the test signal through other logic (338 and 340) via other scan chain boundary cells 342 until the signal reaches scan chain boundary 342c. Thus, there is a domino effect, in which logic 336-340 pass the test only if the expected output is received from scan chain boundary cell 342c. Thus, the present invention may utilize points in this scan chain as tracing points contemplated herein. Alternatively, the soft and hard architected states described above can be streamed out of the caches/registers to initiate an adjustment of trace points while interrupt handler or the next process is executing without blocking access to the caches/registers by the next process or interrupt handler.

### SLIH/FLIH Flash Rom

First Level Interrupt Handlers (FLIHs) and Second Level Interrupt Handlers (SLIHs) may also be stored in system memory, and populate the cache memory hierarchy when called. Normally, when an interrupt occurs in processing unit 204, a FLIH is called, which then calls a SLIH, which completes the handling of the interrupt. Which SLIH is called and how that SLIH executes varies, and is dependent on a variety of factors including parameters passed, conditions states, etc. Because program behavior can be repetitive, it is frequently the case that an interrupt will occur multiple times, resulting in the execution of the same FLIH and SLIH. Consequently, the present invention recognizes that interrupt handling for subsequent occurrences of an interrupt may be accelerated by predicting that the control graph of the interrupt handling process will be repeated and by speculatively executing portions of the SLIH without first executing the FLIH. To facilitate interrupt handling prediction, processing unit 204 is equipped with an Interrupt Handler Prediction Table (IHPT) 122. IHPT 122 contains a list of the base addresses (interrupt vectors) of multiple FLIHs. In association with each FLIH address, IHPT 122 stores a respective set of one or more SLIH addresses that have previously been called by the associated FLIH. When IHPT 122 is accessed with the base address for a specific FLIH, a prediction logic selects a SLIH address associated with the specified FLIH address in IHPT 122 as the address of the SLIH that will likely be called by the specified FLIH. Note that while the predicted SLIH address illustrated may be the base address of the SLIH, the address may also be an address of an instruction within the SLIH subsequent to the starting point (e.g., at point B).

Prediction logic uses an algorithm that predicts which SLIH will be called by the specified FLIH. In a preferred embodiment, this algorithm picks a SLIH, associated with the specified FLIH, which has been used most recently. In another preferred embodiment, this algorithm picks a SLIH, associated with the specified FLIH, which has historically been called most frequently. In either described preferred embodiment, the algorithm may be run upon a request for the predicted SLIH, or the predicted SLIH may be continuously updated and stored in IHPT 122.

Having now reviewed the computing environment, including hard and soft architected states, which the present invention may utilize as tracing parameters, reference is now made to the flow-chart shown in FIG. 4, which depicts exemplary steps taken to dynamically control trace points. After initiator block 402, software is executed using original standard tracing parameters (block 404). Such standard tracing parameters may include a log of previously executed code. At some point in the code execution, a pre-defined condition may be met (query block 406). Such pre-defined conditions may be the existence of a particular soft or hard architected state (as described above in FIGS. 3A-B), a branch or jump to a particular thread of software code (as described in FIG. 1B), an unusually high usage of a particular software object or a warning message generated from a call to an object (see FIG. 1C), a signal from a scan chain test point (described above in FIG. 3C), or any other condition or anomaly defined by a software developer. If such a pre-defined condition exists, and a determination is made that more tracing parameters are needed (query block 408), then the number of tracing parameters is increased (block 410). Such parameters may include, but are not limited to, tracing the contents of units such as L1 I-cache 18, instruction fetch address register (IFAR) 30, branch prediction unit (BPU) 36, global completion table (GCT) 38, branch execution unit (BEU) 92, branch history table (BHT) 35, IFAR 30, instruction sequencing unit (ISU) 118, load/store units (LSUs) 96 and 98, MMU 112, data translation lookaside buffer (DTLB) 113, instruction translation lookaside buffer (ITLB) 115, ERAT 32, instruction fetch buffer (IFB) 40, branch instruction queue 64, instruction translation unit (ITU) 42, latches 44, 46, 48 and 50, CR mapper 52, link and count (LC) register mapper 54, exception register (XER) mapper 56, general-purpose register (GPR) mapper 58, and floating-point register (FPR) mapper 60, CR issue queue (CRIQ) 62, branch issue queue (BIQ) 64, fixed-point issue queues (FXIQs) 66 and 68, floating-point issue queues (FPIQs) 70 and 72, load reorder queue (LRQ) 114, load miss queue (LMQ) 116, store queue (STQ) 110 and IHPT 122.

Data from trace points are stored in non-volatile buffer memory, such as hard drive 234, CD-ROM drive 222, floppy disk drive 224, or flash drive memory 226 shown in FIG. 2. When additional trace points are added, space in this non-volatile buffer memory may be insufficient. If so (query block 412), then the buffer size for the trace point data is increased (block 414).

At some point, the pre-defined condition may no longer be met (query block 416). That is, data from registers described above may return to nominal states, code execution may return to a principal thread, hardware states such as temperature, number of users, etc. may return to normal. If this occurs, then the original standard tracing parameters are re-established and, if necessary, the state data buffer size is returned to normal size (block 418). The process thus ends at terminator block 420.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

### Software Deployment

As described above, in one embodiment, the processes described by the present invention are performed by a service provider server, which may be any one of multiple servers (and described herein as service provider server 250). Alternatively, the method described herein, and in particular as shown and described in FIGS. 1A-C and 4, can be deployed as process software from service provider server 250 to client computer 202 (synonymous with a facilitator computer or a computer system). Still more particularly, process software for the method so described may be deployed to service provider server 250 by another service provider server (not shown).

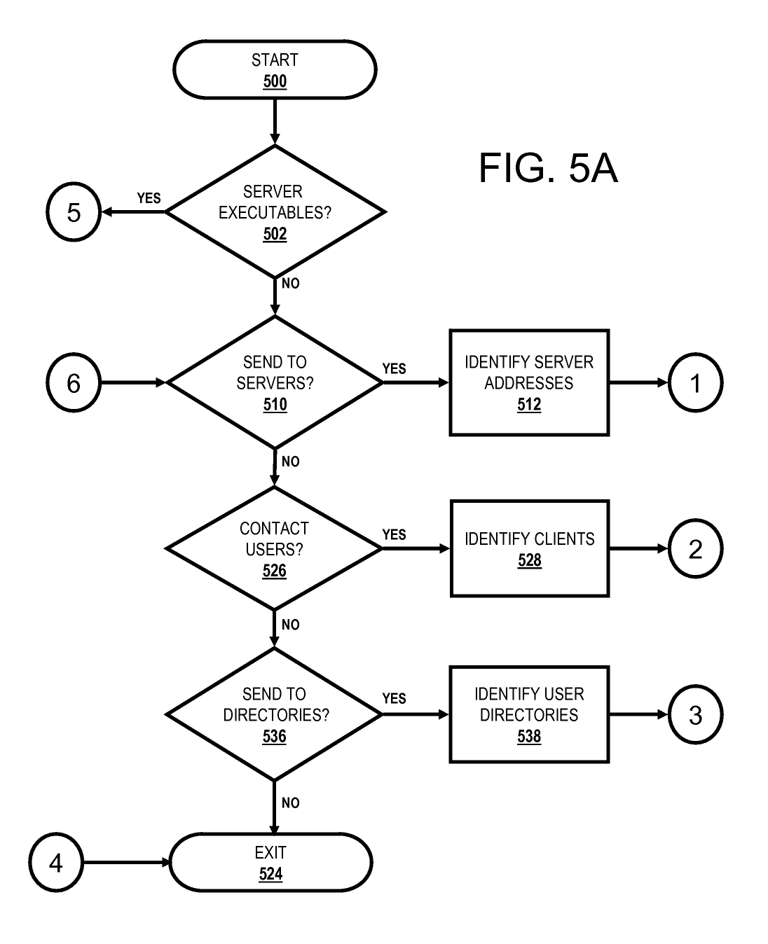

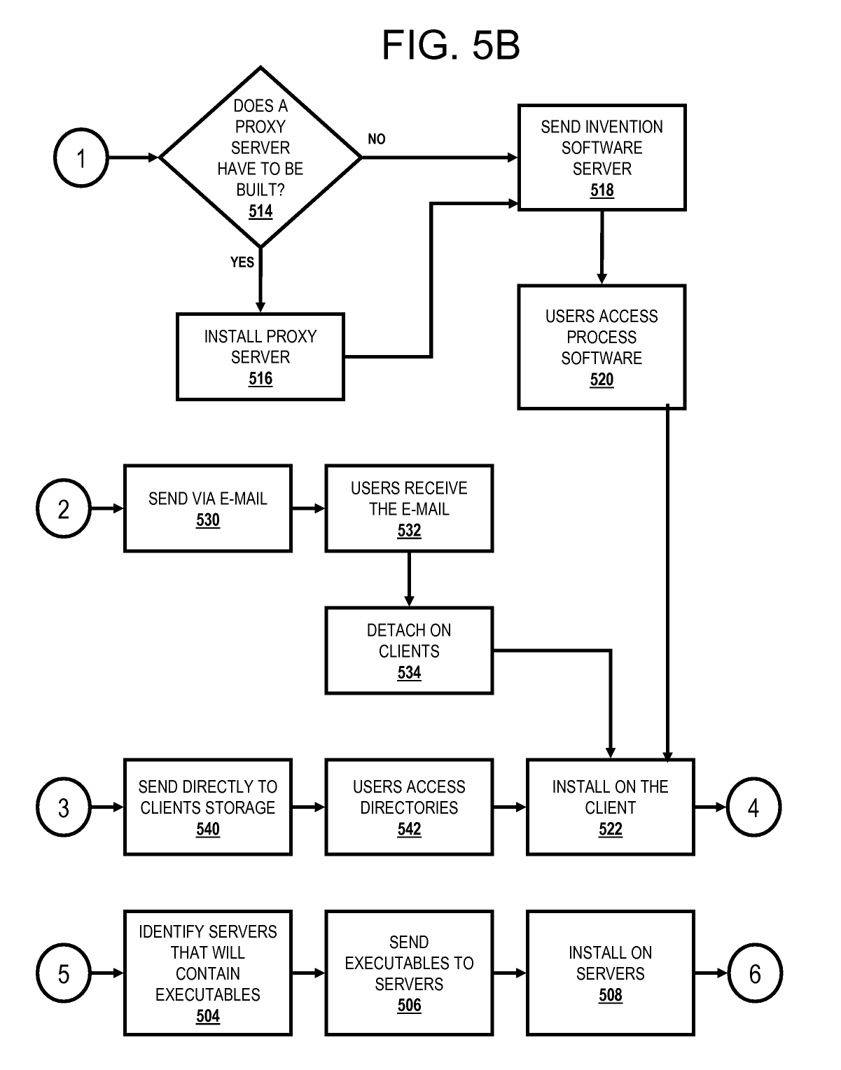

Referring then to FIGS. 5A-B, step 500 begins the deployment of the process software. The first step is to determine if there are any programs that will reside on a server or servers when the process software is executed (query block 502). If this is the case, then the servers that will contain the executables are identified (block 504). The process software for the server or servers is transferred directly to the servers' storage via File Transfer Protocol (FTP) or some other protocol or by copying through the use of a shared file system (block 506). The process software is then installed on the servers (block 508).

Next, a determination is made as to whether the process software is to be deployed by having users access the process software on a server or servers (query block 510). If the users are to access the process software on servers, then the server addresses that will store the process software are identified (block 512).

A determination is made if a proxy server is to be built (query block 514) to store the process software. A proxy server is a server that sits between a client application, such as a Web browser, and a real server. It intercepts all requests to the real server to see if it can fulfill the requests itself. If not, it forwards the requests to the real server. The two primary benefits of a proxy server are to improve performance and to filter requests. If a proxy server is required, then the proxy server is installed (block 516). The process software is sent to the servers either via a protocol such as FTP or it is copied directly from the source files to the server files via file sharing (block 518). Another embodiment sends a transaction to the servers that contained the process software and has the server process the transaction, then receives and copies the process software to the server's file system. Once the process software is stored at the servers, the users, via their client computers, access the process software on the servers and copy the process software to their client computers' file systems (block 520). Another embodiment is to have the servers automatically copy the process software to each client and then run the installation program for the process software at each client computer. The user executes the program that installs the process software on his client computer (block 522) and then exits the process (terminator block 524).

In query step 526, a determination is made whether the process software is to be deployed by sending the process software to users via e-mail. The set of users where the process software will be deployed are identified together with the addresses of the user client computers (block 528). The process software is sent via e-mail to each of the users' client computers (block 530). The users then receive the e-mail (block 532) and detach the process software from the e-mail to a directory on their client computers (block 534). The user executes the program that installs the process software on his client computer (block 522) and then exits the process (terminator block 524).

Lastly, a determination is made as to whether the process software will be sent directly to user directories on their client computers (query block 536). If so, the user directories are identified (block 538). The process software is transferred directly to the user's client computer directory (block 540). This can be done in several ways such as but not limited to sharing the file system directories and then copying from the sender's file system to the recipient user's file system or alternatively using a transfer protocol such as File Transfer Protocol (FTP). The users access the directories on their client file systems in preparation for installing the process software (block 542). The user executes the program that installs the process software on his client computer (block 522) and then exits the process (terminator block 524).

### VPN Deployment

The present software can be deployed to third parties as part of a service wherein a third party VPN service is offered as a secure deployment vehicle or wherein a VPN is built on-demand as required for a specific deployment.

A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e., the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs, the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-free number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a company's multiple fixed sites over a public network such as the Internet.

The process software is transported over the VPN via tunneling, which is the process of placing an entire packet within another packet and sending it over a network. The protocol of the outer packet is understood by the network and both points, called tunnel interfaces, where the packet enters and exits the network.

### Software Integration

The process software which consists of code for implementing the process described herein may be integrated into a client, server and network environment by providing for the process software to coexist with applications, operating systems and network operating systems software and then installing the process software on the clients and servers in the environment where the process software will function.

The first step is to identify any software on the clients and servers, including the network operating system where the process software will be deployed, that is required by the process software or that works in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure that the parameter lists match the parameter lists required by the process software. Conversely, parameters passed by the software applications to the process software will be checked to ensure that the parameters match the parameters required by the software applications. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software where the process software is to be deployed is at the correct version level that has been tested to work with the process software, the integration is completed by installing the process software on the clients and servers.

### On Demand

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, and hours on the central processor of the server. Additionally, the assessed server may make requests of other servers that require CPU units. CPU units are an example that represents but one measurement of use. Other measurements of use include but are not limited to network bandwidth, memory utilization, storage utilization, packet transfers, complete transactions, etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise, when other measurements of use such as network bandwidth, memory utilization, storage utilization, etc., approach a capacity so as to affect performance, additional network bandwidth, memory utilization, storage, etc., are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and/or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

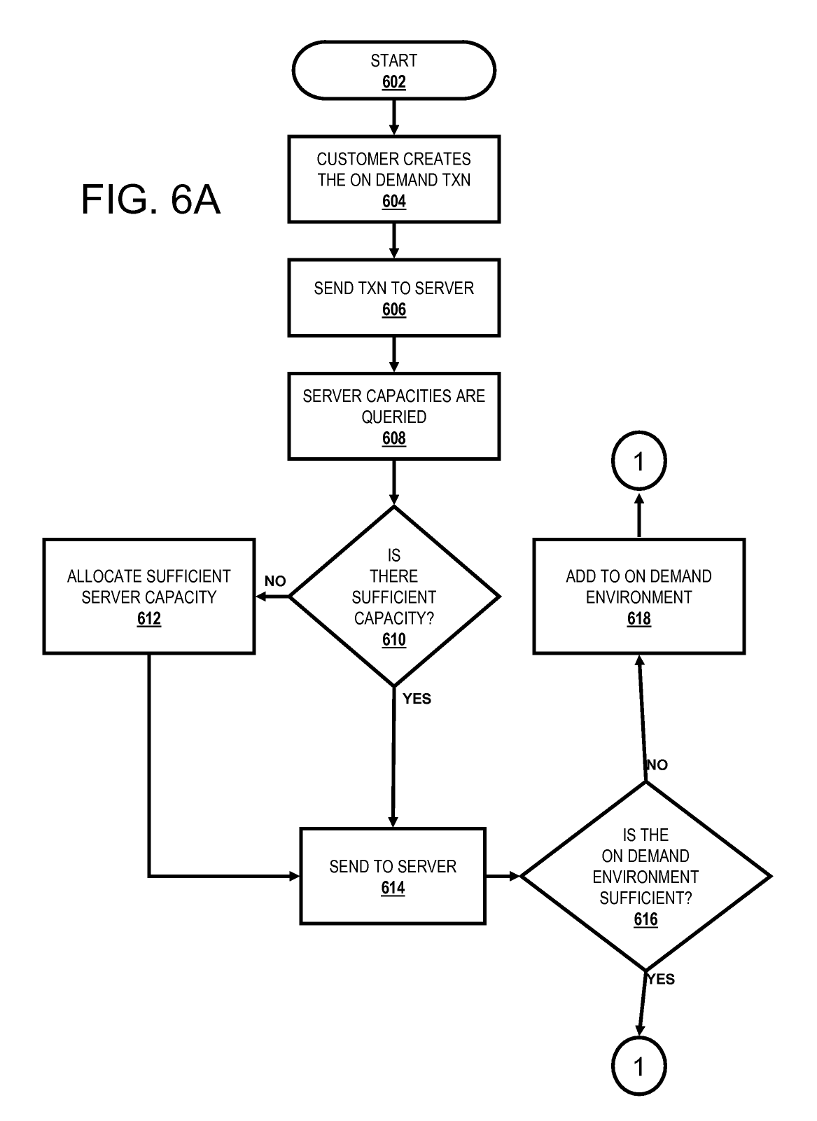

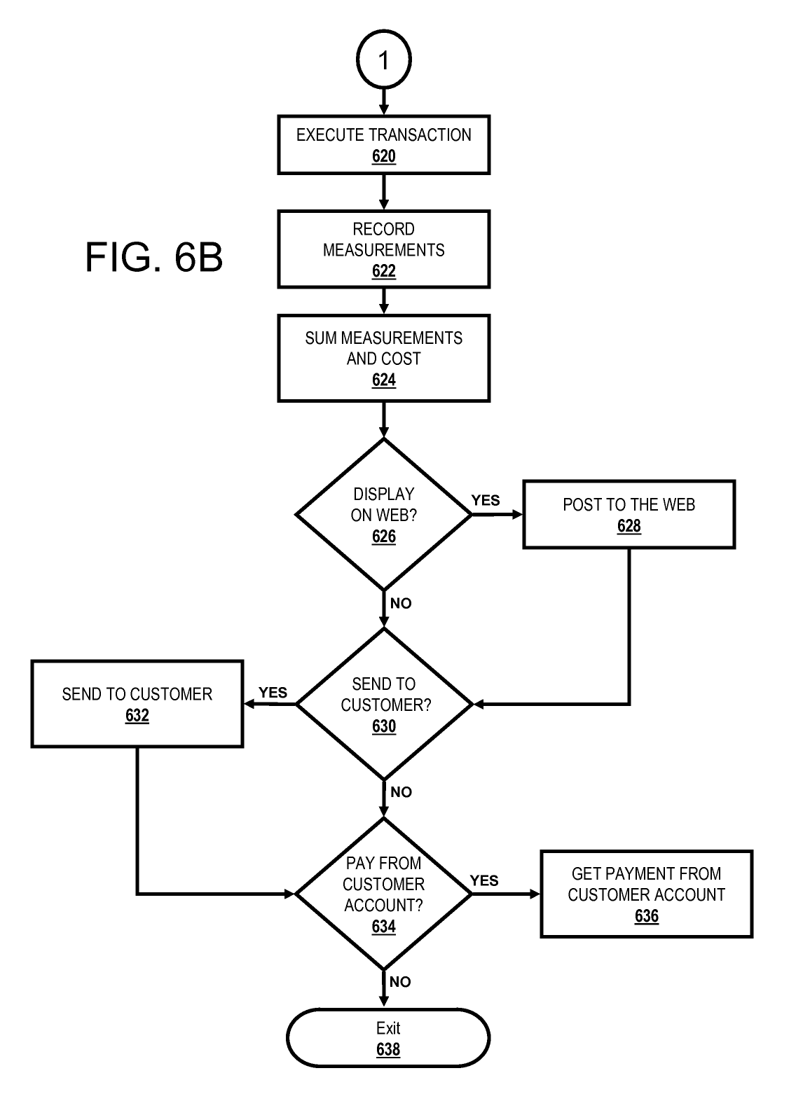

With reference now to FIGS. 6A-B, initiator block 602 begins the On Demand process. A transaction is created that contains the unique customer identification, the requested service type and any service parameters that further specify the type of service (block 604). The transaction is then sent to the main server (block 606). In an On Demand environment, the main server can initially be the only server, then, as capacity is consumed, other servers are added to the On Demand environment.

The server central processing unit (CPU) capacities in the On Demand environment are queried (block 608). The CPU requirement of the transaction is estimated, then the server's available CPU capacity in the On Demand environment is compared to the transaction CPU requirement to see if there is sufficient CPU capacity available in any server to process the transaction (query block 610). If there is not sufficient server CPU capacity available, then additional server CPU capacity is allocated to process the transaction (block 612). If there was already sufficient available CPU capacity, then the transaction is sent to a selected server (block 614).

Before executing the transaction, a check is made of the remaining On Demand environment to determine if the environment has sufficient available capacity for processing the transaction. This environment capacity consists of such things as, but not limited to, network bandwidth, processor memory, storage, etc. (block 616). If there is not sufficient available capacity, then capacity will be added to the On Demand environment (block 618). Next, the required software to process the transaction is accessed, loaded into memory, and the transaction is executed (block 620).

The usage measurements are recorded (block 622). The utilization measurements consist of the portions of those functions in the On Demand environment that are used to process the transaction. The usage of such functions as, but not limited to, network bandwidth, processor memory, storage and CPU cycles are recorded. The usage measurements are summed, multiplied by unit costs and then recorded as a charge to the requesting customer (block 624).

If the customer has requested that the On Demand costs be posted to a web site (query block 626), then they are posted (block 628). If the customer has requested that the On Demand costs be sent via e-mail to a customer address (query block 630), then these costs are sent to the customer (block 632). If the customer has requested that the On Demand costs be paid directly from a customer account (query block 634), then payment is received directly from the customer account (block 636). The On Demand process is then exited at terminator block 638.

The present invention thus provides a method for dynamically adjusting tracing. In one embodiment, the method includes the steps of: embedding, into a software thread, code that causes an adjustment of tracing parameters in response to a pre-defined condition; and in response to determining that the pre-defined condition has been met, adjusting the tracing parameters. The method may further include the step of adjusting a buffer size according to the adjusting of the tracing parameters, wherein a buffer is optimally sized to store data from adjusted tracing parameters. The term “optimally sized” is defined as sizing a buffer to be large enough to handle the data received in accordance with adjusted tracing parameters, while being small enough to avoid wasting buffer space that is not needed to store such data.

The pre-defined condition may be a jump from a first software thread to a second software thread, wherein the second software thread has a history of causing an execution warning. Alternatively, the pre-defined condition may be a particular hard or soft architected state in a processor that is executing software that is being executed.

While the invention has been particularly shown and described with reference to a preferred embodiment, it will be understood by those skilled in the art that various changes in form and detail may be made therein without departing from the spirit and scope of the invention.

What is claimed is:

1. A method for dynamically managing tracing parameters during execution of software code, the method comprising:
embedding, into a software thread, code that causes an adjustment of tracing parameters in response to a pre-defined condition; and
in response to determining that the pre-defined condition has been met, adjusting the tracing parameters.

2. The method of claim 1, further comprising:
adjusting a buffer size according to the adjusting of the tracing parameters, wherein a buffer is optimally sized to store data from adjusted tracing parameters.

3. The method of claim 1, wherein the pre-defined condition is a jump from a first software thread to a second software thread.

4. The method of claim 3, wherein the second software thread has a history of causing an execution warning.

5. The method of claim 1, wherein the pre-defined condition is a particular hard architected state of a processor that is currently executing software that is being traced.

6. The method of claim 1, wherein the pre-defined condition is a particular soft architected state of a processor that is currently executing software that is being traced.

7. A system comprising:
a processor;
a data bus coupled to the processor;
a memory coupled to the data bus; and
a computer-usable medium embodying computer program code, the computer program code comprising instructions executable by the processor and configured for:
embedding, into a software thread, code that causes an adjustment of tracing parameters in response to a pre-defined condition; and
in response to determining that the pre-defined condition has been met, adjusting the tracing parameters.

8. The system of claim 7, wherein the instructions are further configured for:
adjusting a buffer size according to the adjusting of the tracing parameters, wherein a buffer is optimally sized to store data from adjusted tracing parameters.

9. The system of claim 7, wherein the pre-defined condition is a jump from a first software thread to a second software thread.

10. The system of claim 9, wherein the second software thread has a history of causing an execution warning.

11. The system of claim 7, wherein the pre-defined condition is a particular hard architected state of a processor that is currently executing software that is being traced.

12. The system of claim 7, wherein the pre-defined condition is a particular soft architected state of a processor that is currently executing software that is being traced.

13. A computer-readable medium embodying computer program code for dynamically managing tracing parameters during execution of software code, the computer program code comprising computer executable instructions configured for:
embedding, into a software thread, code that causes an adjustment of tracing parameters in response to a pre-defined condition; and
in response to determining that the pre-defined condition has been met, adjusting the tracing parameters.

14. The computer-readable medium of claim 13, wherein the computer executable instructions are further configured for:
adjusting a buffer size according to the adjusting of the tracing parameters, wherein a buffer is optimally sized to store data from adjusted tracing parameters.

15. The computer-readable medium of claim 13, wherein the pre-defined condition is a jump from a first software thread to a second software thread.

16. The computer-readable medium of claim 15, wherein the second software thread has a history of causing an execution warning.

17. The computer-readable medium of claim 13, wherein the pre-defined condition is a particular hard architected state of a processor that is currently executing software that is being traced.

18. The computer-readable medium of claim 13, wherein the pre-defined condition is a particular soft architected state of a processor that is currently executing software that is being traced.

19. The computer-readable medium of claim 13, wherein the computer-usable medium is a component of a remote server, and wherein the computer executable instructions are deployable to a client computer from the remote server.

20. The computer-readable medium of claim 13, wherein the computer executable instructions are capable of being provided by a service provider to a customer on an on-demand basis.
